(19) United States
(12) Patent Application Publication
(10) Pub. No.: US 2009/0274799 A1
(43) Pub. Date: Nov. 5, 2009

(54) Seasoning Bag

(76) Inventors: Roger V. Lee, San Ramon, CA (US); Robert T. Dorsey, Orland Park, IL (US); Kara L. Harl, Naperville, IL (US)

Correspondence Address: THE CLOROX COMPANY, P.O. BOX 24305, OAKLAND, CA, 94623-1305, US

(21) Appl. No.: 12/303,168

(22) PCT Filed: May 29, 2007
(86) PCT No.: PCT/US07/69849

§ 371 Date: Dec. 2, 2008

Related U.S. Application Data
(60) Provisional application No. 60/804,755, filed on Jun. 14, 2006.

(51) Int. Cl. B65D 81/34; B65D 85/00; A23L 1/22; B65D 30/10

(52) U.S. Cl. 426/107; 426/106; 426/118; 426/108

(57) ABSTRACT

A bag for applying seasoning to a food item is provided. The bag comprises a mouth, an interior surface, and a seasoning. The mouth receives the food item, and the seasoning is adhered to at least a portion of the interior surface such that the food item may be seasoned if placed through the mouth into the bag. In another embodiment, the bag may comprise a compartment for holding a seasoning. The compartment may have a releasable seal to release the seasoning on the food item. The bag may be provided to the consumer in a container such that the consumer may remove the bag from the container and place a food item in the bag to season the food item.

### FIELD OF THE INVENTION

The invention pertains to storage bags suitable for use in the containment and protection of food items, and more particularly storage bags used to season a food item.

### BACKGROUND OF THE INVENTION

The use of storage bags for containing items, such as food items, is generally known in the art. These bags are typically constructed of a film with an open mouth disposed near the upper end of the bag. Often a closure will be provided such that the open mouth may be sealed to prevent the item from exiting the bag, restrict the exposure of the item to external air exposure, and prevent contact of the food item with external contaminants.

One application of these types of storage bags is the use of the storage bag to season a food item by, for example, marinating the food item within the bag. For example, it may be desirable to marinate a piece of meat for a period of time before cooking. The meat absorbs and/or is coated with the marinade to add flavor to the meat. These types of storage bags provide an inexpensive and disposable medium for containing the food item and seasoning mixture. Typically, the marinade mixture is a liquid or solid mixture and consumers must measure and add the proper amount of seasonings to the bag. This is usually a messy, time consuming, and inconvenient endeavor. Thus, there is a need for a storage bag that makes seasoning food items in storage bags cleaner, faster, and more convenient.

### BRIEF SUMMARY OF THE INVENTION

The invention provides a bag for applying seasoning to a food item. The bag comprises a mouth, an interior surface, and a seasoning. The mouth receives the food item, and the seasoning is adhered to at least a portion of the interior surface such that the food item may be seasoned if placed through the mouth into the bag.

The invention further provides another bag for applying seasoning to a food item. The bag comprises a first compartment, a second compartment, and a seal. The first compartment stores the food item and has a reclosable mouth for receiving the food item. The second compartment stores the seasoning. The seal is disposed to enclose the second compartment and is releasable to permit the seasoning to enter the first compartment and season the food item.

The invention also provides a seasoning application kit for enabling a consumer to season a food item. The kit comprises a seasoning bag and a container for storing the bag prior to use. The bag comprises an interior surface having a seasoning adhered at least partially thereon and an open mouth for inserting a food item into the bag. The container has an opening for removing the bag from the container. The consumer removes the bag from the container and inserts the food item into the open mouth to season the food item.

### BRIEF DESCRIPTION OF THE DRAWINGS

FIG. 1 is a perspective view of a seasoning bag;

FIG. 2 is an elevational front side view of the seasoning bag of FIG. 1;

FIG. 3 is a cross-sectional view taken through line 3-3 of FIG. 2 showing the seasoning bag of FIG. 1;

FIG. 4 is a cross-sectional view taken through line 3-3 of FIG. 2 showing the seasoning bag of FIG. 1 with an item of food disposed therein;

FIG. 5 is a cross-sectional view showing another embodiment of the invention;

FIG. 6 is a cross-sectional view showing the embodiment of FIG. 5 with an item of food disposed therein;

FIG. 7 is a cross-sectional view showing another embodiment of the invention;

FIG. 8 is a cross-sectional view showing the embodiment of FIG. 7 with an item of food disposed therein;

FIG. 9 is a cross-sectional view showing the embodiment of FIG. 7 after microwaving and with an item of food disposed therein;

FIG. 10 is a cross-sectional view showing another embodiment of the invention;

FIG. 11 is a cross-sectional view showing the embodiment of FIG. 10 with an item of food disposed therein;

FIG. 12 is a cross-sectional view showing the embodiment of FIG. 10 with an item of food disposed therein and a seasoning released over the food item;

FIG. 13 is a perspective view showing another embodiment of the invention;

FIG. 14 is a cross-sectional view showing the embodiment of FIG. 13 after air has been removed from the bag and with an item of food disposed therein; and

FIG. 15 is a perspective view of a container of seasoning bags.

### DETAILED DESCRIPTION OF THE INVENTION

The invention provides a storage bag 100 suitable for seasoning a food item. The seasoning bag 100 comprises a seasoning such as a marinade or curing mixture disposed within the bag 100 prior to purchase by a consumer. In this way, the seasoning is already prepared and measured in a desired quantity before a consumer opens the bag 100. Thus, a consumer saves time and avoids the hassle of preparing and measuring the seasoning. Furthermore, the seasoning bag 100 has a structure suitable to apply the seasoning in a uniform manner over the outer surface of a food item with minimal effort by the consumer.

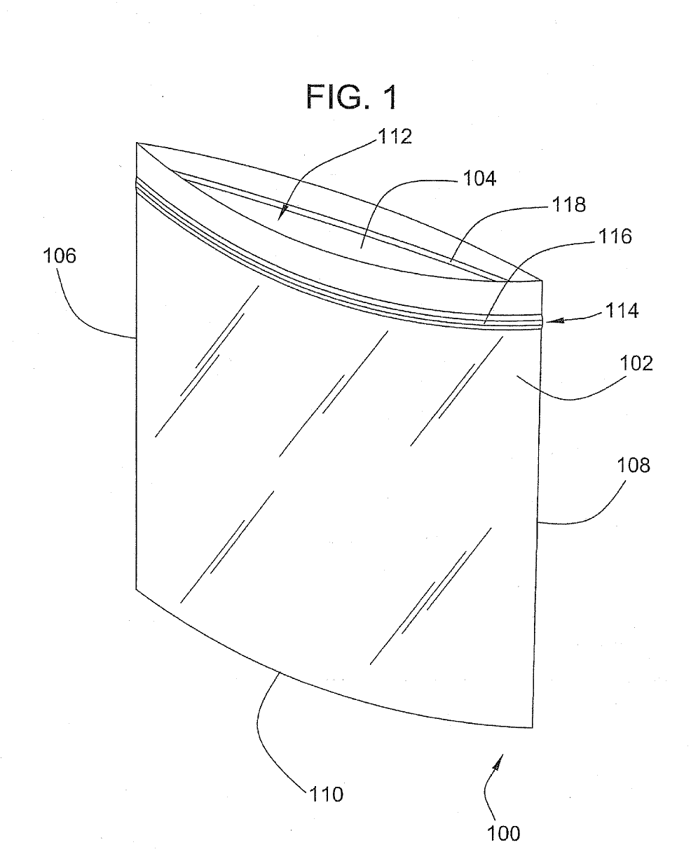

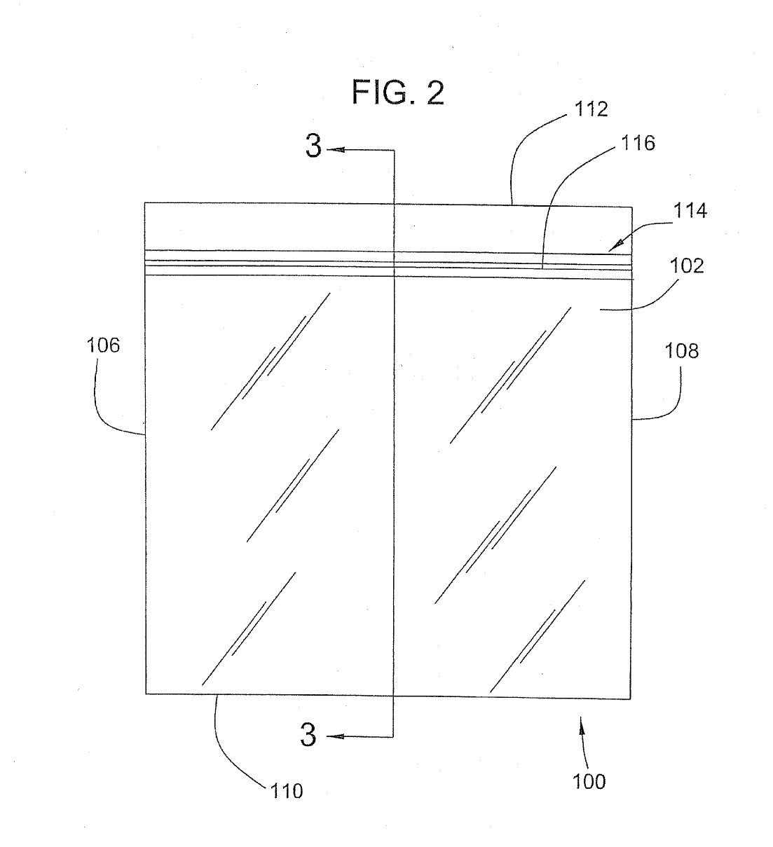

Referring to FIGS. 1 and 2, a reclosable seasoning bag 100 is shown. The seasoning bag 100 generally includes two opposing sidewalls 102, 104 that are attached together along a portion of a periphery of the sidewalls 102, 104, such as along longitudinal edge seams 106, 108 and along a laterally extending bottom edge 110. In the illustrated seasoning bag 100, the longitudinal edge seams 106, 108 may be formed by sonic welding, heat sealing, an adhesive or other conventional attachment means along the edges of the material forming the sidewalls 102, 104, and the bottom edge 110 may be defined by a fold in the material forming the sidewalls 102, 104. Further, the bottom edge 110 may also include an edge seam formed in a manner similar to that of the longitudinal edge seams 106, 108.

An upper end of the bag 100 includes a mouth 112 for insertion of articles into the interior of the bag 100. A reusable closure 114 comprising complementary mating elements 116, 118 may be located on the interior of the sidewalls 102, 104 near the mouth 112 for reclosably sealing the mouth 112 of the bag 100. For example, the reusable closure 114 may comprise an adhesive closure or an interlocking seal type closure, and may or may not include a slider for manipulating opening and closing of the bag 100. It will be appreciated, however, that any suitable closure 114 may be used.

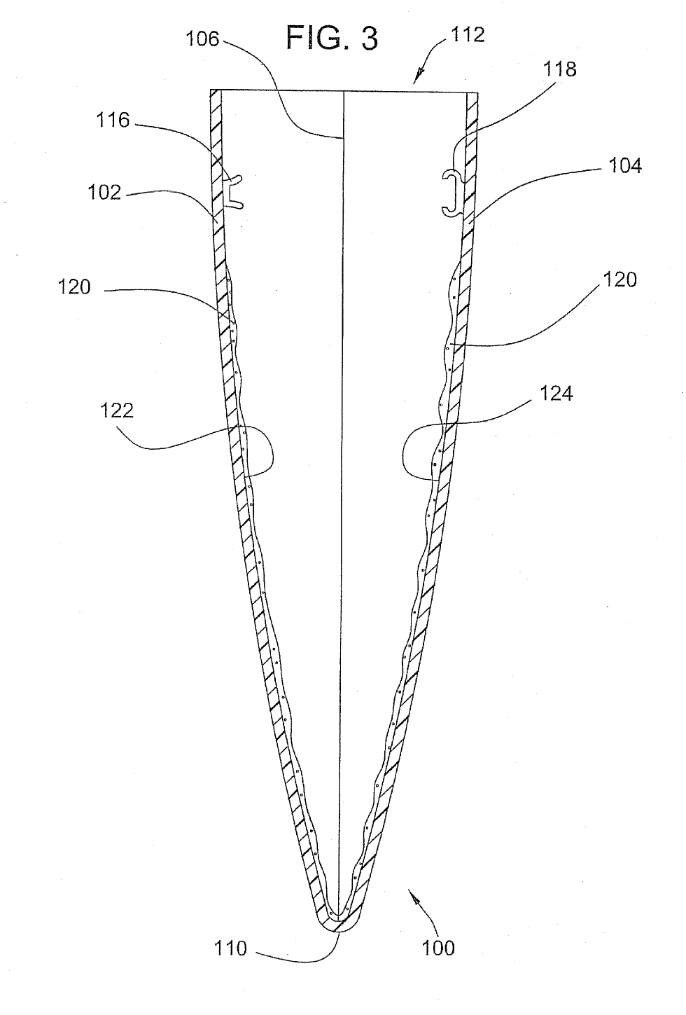

Turning to FIG. 3, the bag 100 may have a coating of seasoning 120 disposed along at least a portion of the internal surface 120, 122 of at least one sidewall 102, 104 of the bag 100. The seasoning 120 may be of any suitable type and may be adhered to the sidewall 102, 104 via any suitable manner. For example, a layer of adhesive may be disposed on a sidewall 102, 104 with the seasoning disposed thereon, or in other embodiments, the adhesive may be intermixed with the seasoning such that the seasoning is adhered to a sidewall 102, 104. The seasoning 120 may be adhered to the sidewalls 102, 104 of the bag 100 such that the seasoning 120 may be substantially evenly dispersed and may resist the accumulation of seasoning 120 to a particular portion of the bag 100 (e.g., collect near the bottom of the bag 100 when disposed upright). For example, a food-safe edible adhesive may be utilized to adhere the seasoning 120 to the sidewall 102, 104. The adhesive may comprise a temperature and/or time activated adhesive. For example, the adhesive may be a cold temperature release adhesive suitable to permit the marinating of a food item in the refrigerator and/or freezer. The adhesive may be activated by the inherent moisture of the food item and/or through the addition of a liquid by the user (such as oil, water, lemon juice, etc.). Thus, the amount of seasoning 120 applied to the food item may be controlled based on the moisture content of the food item and/or any liquids added to the bag 100.

As used herein, “adhesive” or “adhesive materials” include all materials typically considered for use to adhere one material to a target surface. Adhesive materials include, but are not limited to, glues, solvent-based adhesives, emulsions, and hot-melt pressure sensitive adhesives. An adhesive may be applied to the seasoning bag by any conventional application method known in the industry. This includes, but is not limited to, roller application, spray, coating, printing, transfer, extrusion, brush, pads, or combinations thereof.

Examples of suitable adhesives may include any cereal or root starch or flour, such as, but not limited to, maize, rice, barley, wheat, sorghum, tapioca, potato, corn starch, and the waxy versions thereof, and the corresponding flours. Converted, i.e., acid treated starches or chemically modified starches may also be used.

In some embodiments, water-soluble carbohydrates including monosaccharides, disaccharides, and trisaccharides may be used to form an adhesive and include, but are not limited to, sorbitol, mannitol, maltitol, lactitol, fructose, glucose, sucrose, corn syrups, maltodextrin, or combinations thereof. An example of a carbohydrate based adhesive is N-TACK®, a maltodextrin based product made by National Starch and Chemical.

In other embodiments, organic macromolecular adhesives may be used and include, but are not limited to, proteins, zein, casein, shellac, cellulose, gelatin amide-containing polymers, pectin, or PNVP polymers such as poly-N-vinylpyrrolidone, poly-N-vinyl-N-methylacetamide, polyacrylamide, polymethacrylamide, poly-N,N-dimethylacrylamide, poly-N, N-dimethylmethacrylamide, poly-N-vinylpiperidone, polyethyloxazoline, or combinations thereof.

Edible gums may also be used to form an adhesive and include, but are not limited to, vegetable gums, such as guar gum, carob bean gum, gum tragacanth, xanthan gum, tamarind gum, locust bean gum, arabic gum and karaya gum; marine gums, such as carrageenan and alginate; cellulose gum, such as carboxymethyl cellulose, and mixtures thereof.

In further embodiments, edible fats, or oils may also be used and include, but are not limited to, safflower oil, olive oil, cottonseed oil, rapeseed oil, corn oil, canola oil, soybean oil, palm oil, rice (bran and germ) oils, sunflower oil, sesame oil, lard, beef tallow, fish oil, butter, and mixtures thereof.

Combinations of the materials described above may be used to form an adhesive as well. An example of an adhesive composition made by combining a number of the above ingredients includes the combination of maltodextrin, whey protein concentrate, and xanthan gum, with a balance of water, which is blended until the mixture is smooth.

While specific compositions suitable as adhesives and as curing or marinating agents have been described herein, it will be appreciated that many other such compositions could be formulated within the scope of the invention. Further examples of suitable adhesives may be found in U.S. Pat. Nos. 6,623,773 and 4,501,758, which are incorporated in their entirety herein. It will be appreciated, however, that any suitable adhesive may be used, and in certain embodiments, the seasoning 120 may be capable of retaining itself to the sidewalls 102, 104 of the bag 100. In other embodiments, the seasoning may be dispensed in an uneven pattern. For example, the seasoning may be located in the area where the food will reside, such as, the center of the bag.

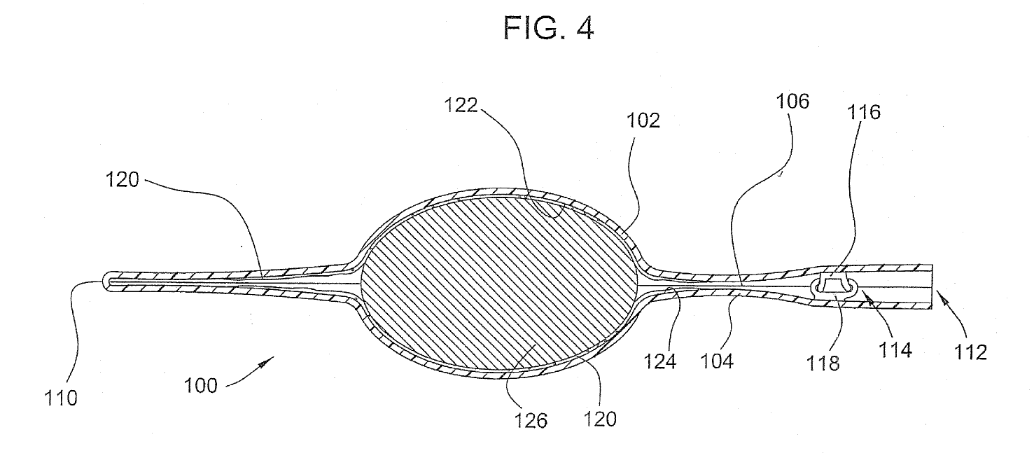

As shown in FIG. 4, when a food item 126 is disposed within the bag 100, the bag 100 may be closed via the closure 114. A user may conform the bag 100 around the food item 126 by applying external pressure on the bag 100 and food item 126. As discussed above, through the addition of a liquid prior to closure and/or through the natural moisture in the food item 126, the adhesive may release the seasoning 120 such that at least some of the seasoning 120 attaches to the food item 126. Given the relatively even distribution of seasoning 120 on the interior surface of the bag 100, the food item 126 is relatively evenly coated by the seasoning 120 to provide a desired flavoring to the food item 126. The user need not shake or rub the food item 126, thus saving the consumer time, creating less mess, and making the process more convenient.

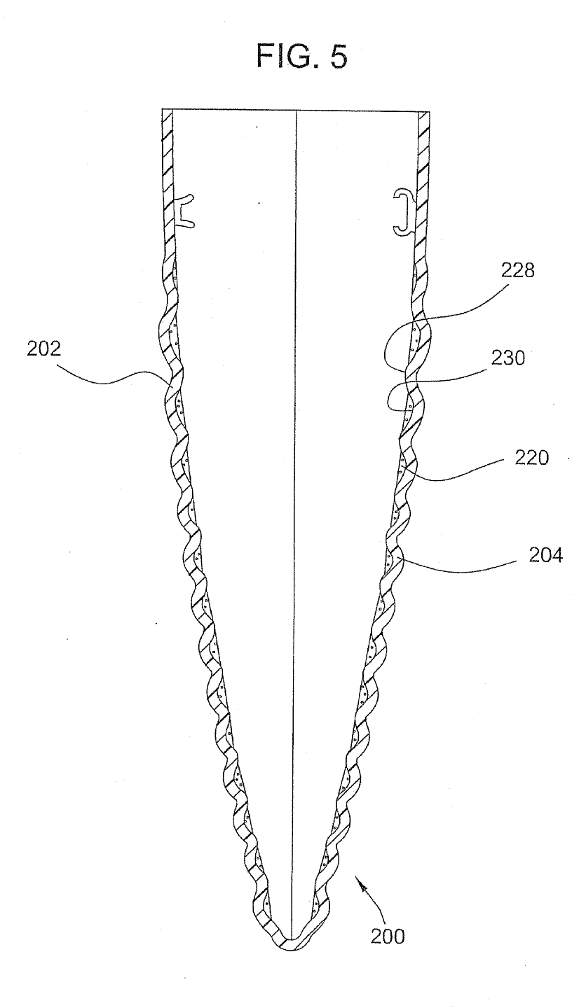

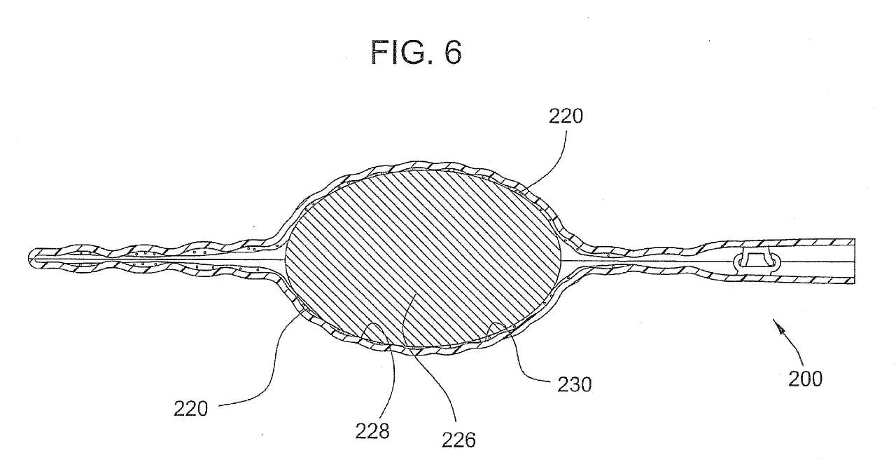

Turning to FIG. 5, another embodiment of a seasoning bag 200 similar to the previous embodiment is disclosed. The bag 200 may have a plurality of protrusions 228 and valleys 230, such as may be formed by an embossing operation, wherein the valleys 230 are at least partially filled with a seasoning 220. As discussed above, the seasoning may be adhered to the sidewalls 202, 204 within the valleys 230 by a layer of adhesive between the seasoning and the respective sidewall 202, 204, the adhesive may be intermixed with the seasoning, and/or the seasoning may have properties such that it retains itself within the valleys without the use of an adhesive. The seasoning 220 is held out of engagement with an adjacent surface (such as a food item) by the protrusions until a sufficient pressure (such as through direct compression or vacuum force) is applied to the sidewall 202, 204 causing at least some of the protrusions 228 and valleys 230 to collapse and allow contact of the seasoning 220 with the food item. Thus, as shown in FIG. 6, a food item 226 may be disposed within the bag 200, and the bag 200 may be pressed against the food item 226 to apply the seasoning 220 to the surface of the food item 226. In this way, the seasoning 220 is selectively applied to the food item 226 at the time that pressure is applied. It will be appreciated that any suitable quantity of valleys 230 having any suitable size and shape may be used to retain the seasoning 220. Examples of suitable structures for containing seasoning, applying seasoning, and/or for use in conjunction with the present invention may be found in U.S. Pat. Nos. 5,662,758; 5,871,607; 5,965,224; 5,965,235; 5,968,633; 6,099,940; 6,156,363; 6,193,918; 6,194,062, U.S. Patent Application Publication Nos. 2003/0057206, 2005/0286817, and U.S. application Ser. No. 11/341,088, filed 27 Jan. 2006, and titled Storage Bag, (492.578, LVM 232461), all of which are incorporated in their entirety herein.

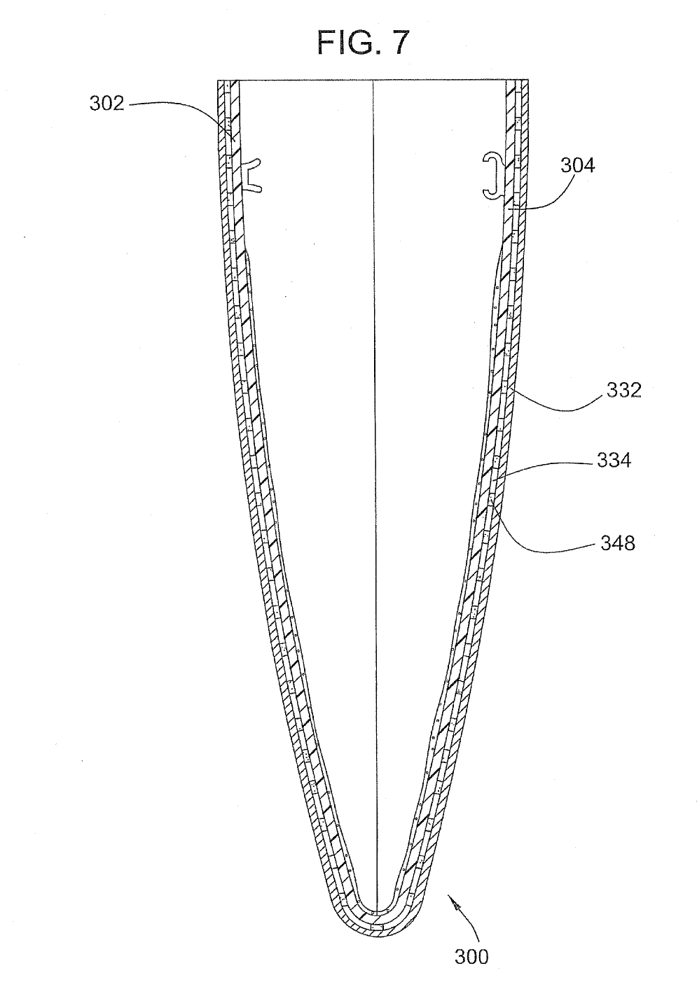

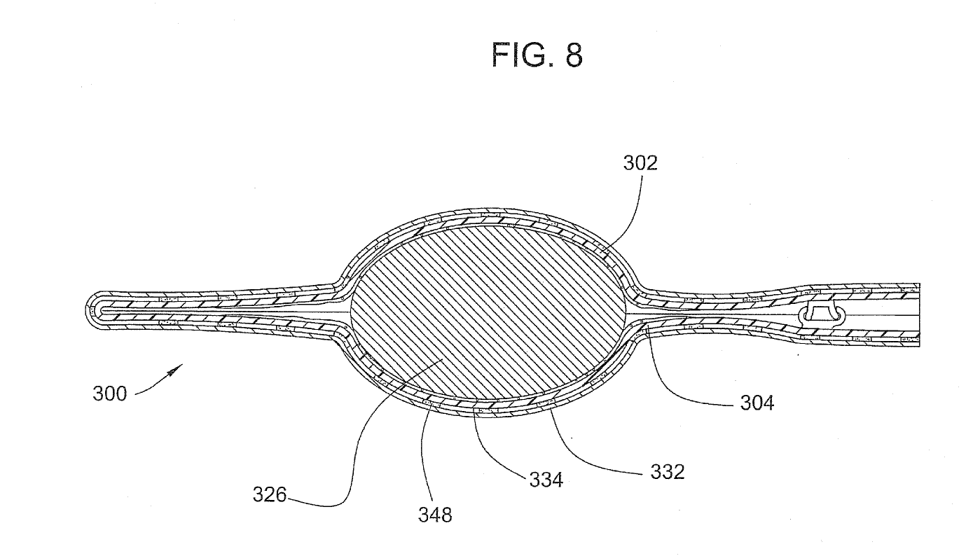

Turning to FIGS. 7 and 8, another embodiment of a seasoning bag 300 similar to the previous embodiments is disclosed. One problem with microwaving certain foods is that the food often turns out to be soggy and lacks a desirable browning and crisping on the exterior surface of the food item. To address this problem, the seasoning bag 300 may comprise a microwave susceptor material to enhance the browning and crisping of the food item when cooking the food item in a microwave oven. Thus, the seasoning process may take place prior to and/or during the cooking process. In one embodiment, the susceptor material may be part of the film forming the sidewalls 302, 304. In another embodiment, the susceptor material may be a separate layer in addition to sidewalls 302, 304. It will be appreciated that any suitable susceptor material may be utilized.

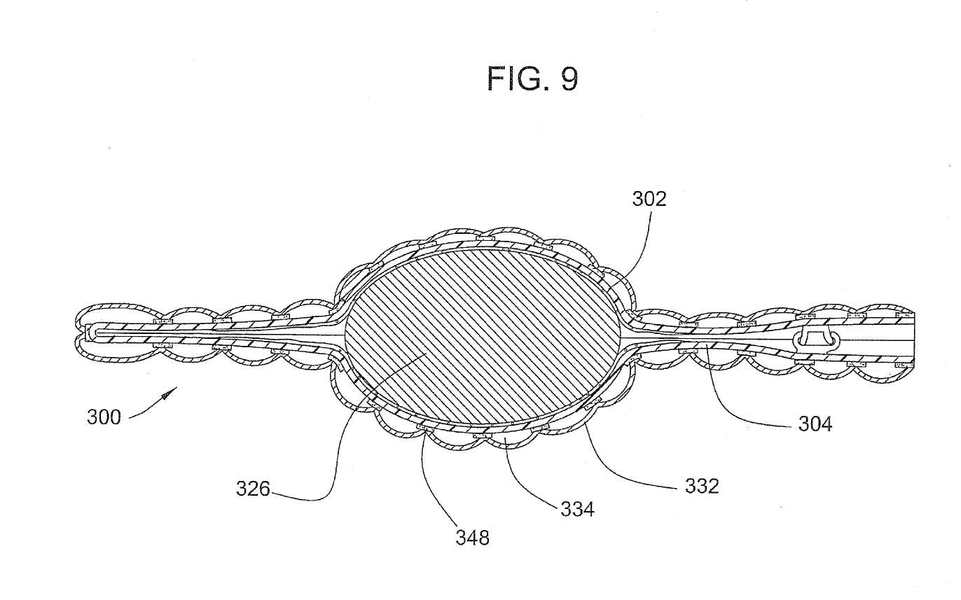

The bag 300 may further comprise a substrate layer 332 disposed on the outer surface of the layer comprising the susceptor material. The substrate layer 332 may be constructed of any suitable material, including but not limited to, a paper material, a woven material, a non-woven material, a foam material, or a paperboard material. The substrate layer 332 may be selectively adhered with adhesive 348 to the layer comprising the susceptor material such that one or more pockets 334 are formed between the layer comprising the susceptor material and the substrate layer 332. As shown in FIG. 9, the pockets 334 may inflate (e.g., through the evaporation of moisture present in the susceptor layer) to raise the food item 326 and/or the bag 300 may shrink during the microwave cooking process to help conform the bag 300 around the food item 326 such that the entire surface of the food item 326 may experience a relatively even browning, crisping, and seasoning. The air pockets 334 also may act as insulators to aid in the cooking process by reducing heat loss. The microwavable seasoning bag 300 may be constructed in any suitable manner, including, but not limited to embodiments disclosed in U.S. application Ser. No. ______, filed ______, and titled Microwavable Bag or Sheet Material, (492.692, LVM 242085), U.S. Pat. Nos. 4,268,738; 5,003,142; 5,081,330; 5,177,332; 5,317,118; 6,303,913; 6,414,288; and 7,019,271, and U.S. Patent Application Publication Nos. 2005/0205565 and 2005/0230384, all of which are incorporated in their entirety herein.

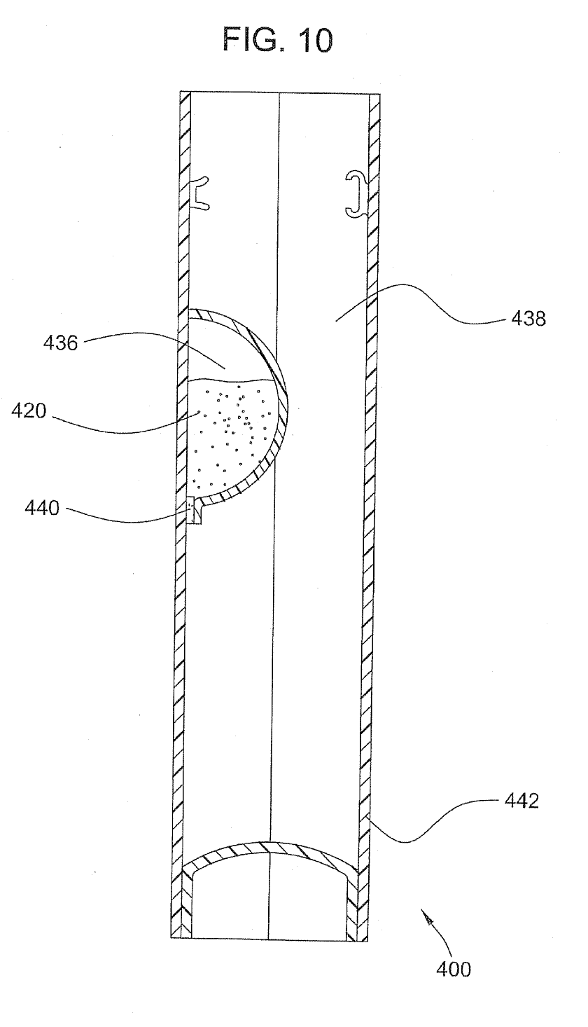

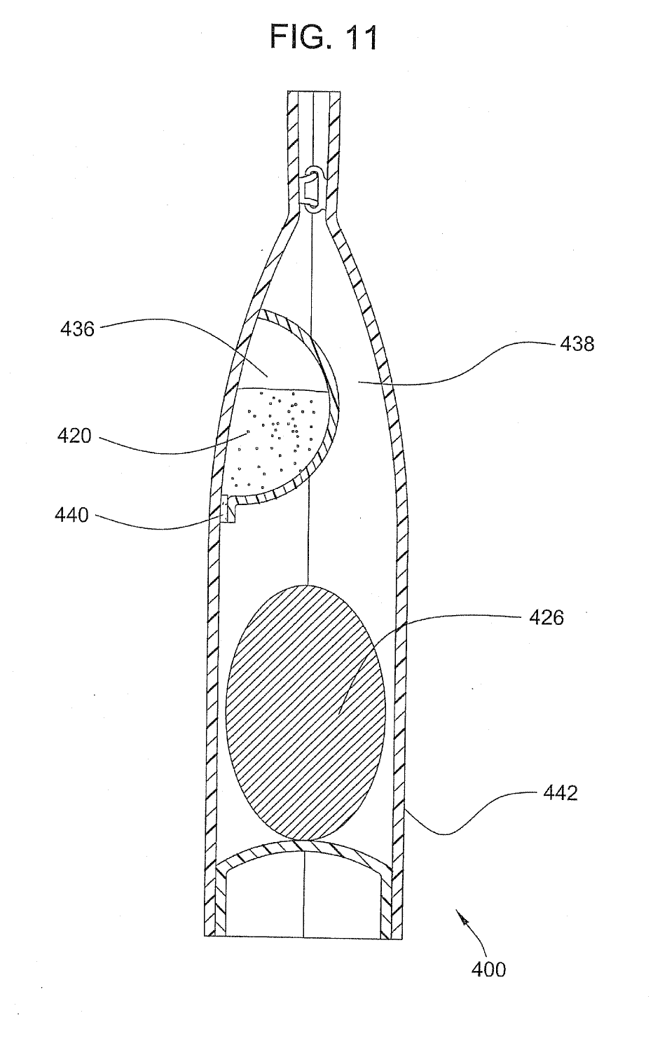

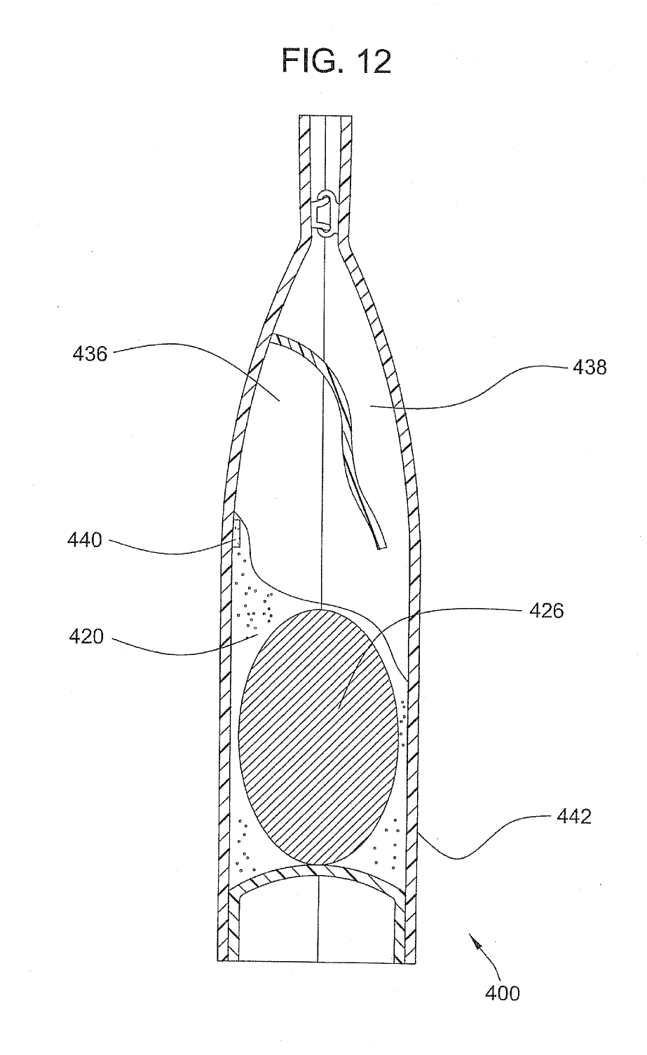

In certain embodiments, it may be desirable to add a seasoning during or after the cooking process. Referring to FIG. 10, another embodiment of a seasoning bag 400 similar to the previous embodiments is disclosed. The bag 400 may comprise a seasoning storage area 436 for the seasoning 420 that is separate from the main storage area 438 of the seasoning bag 400 for storing food items. A consumer may purchase the bag 400 with the seasoning already disposed in the seasoning storage area 436 and may insert a food item of choice into the main storage area 436. In another embodiment, the storage area 436 may be empty and the user adds the seasoning 420 to the storage area 436. A seal/bond line 440 may be formed between the seasoning storage area 436 and the main storage area 438 of the bag 400. Thus, as shown in FIG. 11, the seasoning 420 is not in contact with the food item when the food item is initially placed into the bag 400. The bond line 440 may be selectively releasable and/or the bond line 440 may be formed of a material that will release due to heat, pressure, and/or steam applied to the bond line 440 during the cooking process (e.g., in a microwave oven). Thus, as shown in FIG. 12, before, during, or after cooking, the bond line 440 releases to permit the seasoning 420 to fall onto the food item 426 to season or coat the food item 426. To facilitate the seasoning 420 falling on the food item 426, the bag 400 may have one or more support structures 442 suitable for orienting the bag 400 in an upright position.

It will be appreciated that the seasoning bag 400 may have any suitable number of storage compartments separating any suitable number of seasonings 420. It will further be appreciated that embodiments having multiple bond lines 440 may be constructed such that the bond lines 440 release at approximately the same time or at any suitable differing times before, during, or after the cooking process. The bond line 440 may be formed of any material suitable for sealing the seasoning area 436 from the main storage area 438 such that the bond line may release before, during, and/or or after cooking to apply a seasoning 420 to a food item 426.

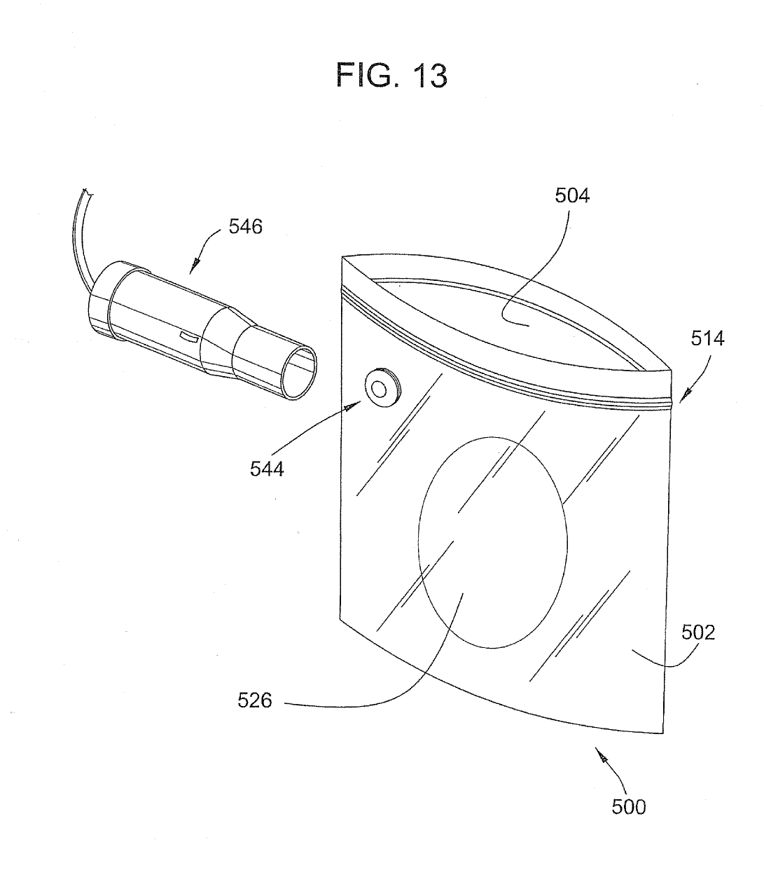

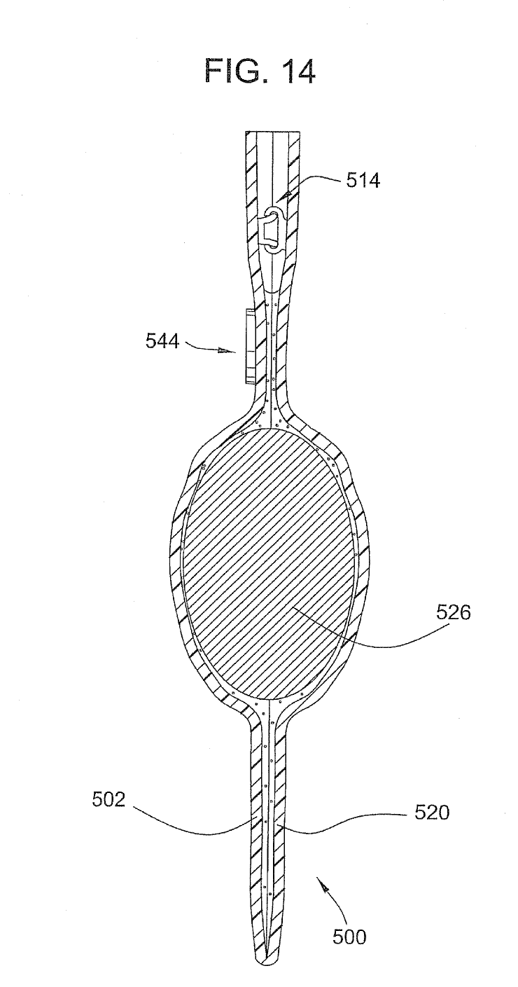

Referring to FIG. 13, another embodiment of a seasoning bag 500 similar to the previous embodiments is disclosed. The marinade bag 500 may comprise a valve 544 for receiving a vacuum device 546. The valve 544 permits a user to remove air from the interior of the bag 500 when the bag 500 is closed. When a food item 526 is inserted into the bag 500 and the bag 500 is closed via the closure 514, the vacuum device 546 may be positioned over the valve 544. The vacuum device 546 may be used to remove a desired amount of air out of the bag 500. This causes the sidewalls 502, 504 of the bag 500 to closely conform around the food item 526, as shown in FIG. 14. Thus, the valve 544 and vacuum device 544 permits an intimate contact of the seasoning 520 with substantially the entire exterior surface of the food item 526. As explained above, this close contact helps to obtain uniform seasoning of the food item 526.

It will be appreciated that any suitable vacuum device 546 may be used to remove air from the seasoning bag 500. Furthermore, any suitable type of valve may be used. Having the seasoning adhered to the sidewalls 502, 504 of the bag 500 permits the vacuum operation to take place without adversely affecting the application of the seasoning 520 to the food item 526. For example, if the seasoning 520 were not adhered to the sidewalls 502, 504, then the sucking action of the vacuum device 546 may remove substantial amounts of seasoning 520 out of the bag 500, which would waste seasoning 520 and ruin any seasoning measurements made by the consumer and uncontrollably altering the amount of seasoning applied to the food item 526. In addition, the seasoning may clog the valve. In one embodiment, the valve may include a filter to prevent clogging of the valve. By coating the bag with seasoning, the air may take a tortuous path in order to be expelled through the valve and thus the amount of moisture and liquid from the food will be reduced from exiting the valve. The seasoning on the sidewall is also a way to omit or reduce the need for an embossed bag in order to create a tortuous path to separate air from liquids so that air can be expelled through the valve.

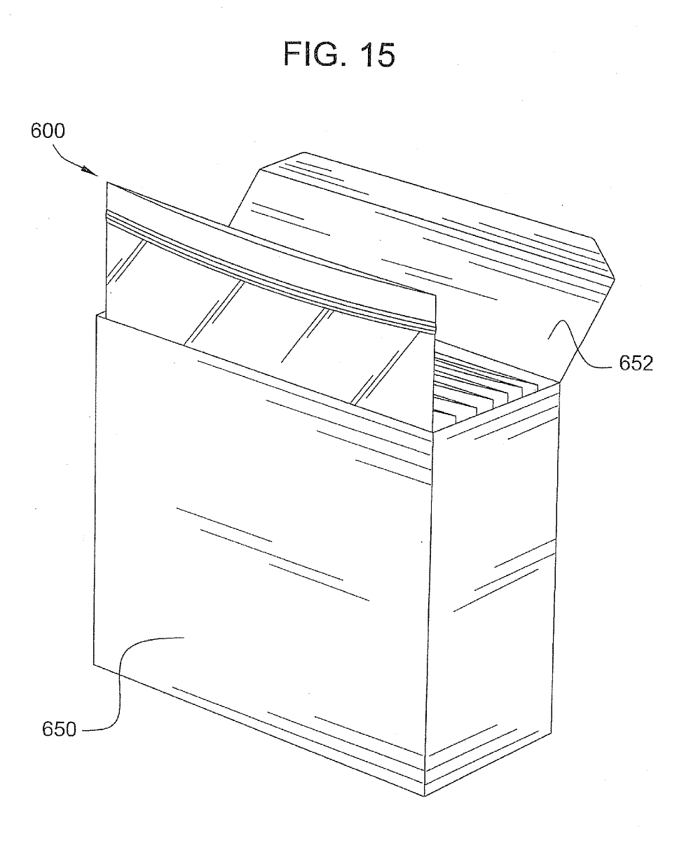

Turning to FIG. 15, one or more seasoning bags 600 may be provided to a consumer in a container 650. The bags 600 may include seasoning as noted herein. The container 650 is sealed when sold to the consumer. The consumer opens the container 650 to remove seasoning bags 600. Once a seasoning bag 600 is removed, the consumer may insert a food item into the bag 600 to season the food item. As described above, the seasoning may interact with the food item to season the food item before, during, and/or after cooking. The container 650 may have a reclosable lid 652 that may be closed after removing a seasoning bag 600 to help preserve any seasoning bags 600 remaining in the container 650. Thus, seasoning bags 600 may be provided to the consumer in a convenient manner such that the consumer may easily season a food item.

The seasoning may be applied to the interior of the bag via any suitable process. For example, in one embodiment, the bag may be coated with an edible adhesive and a spice duster may apply the seasoning. In another embodiment, sheets coated with a seasoning may be inserted and sealed to the interior of the bag (by laminating or spot sealing, for example). Additional examples of processes for coating a material with an adhesive and seasoning may be found in U.S. Pat. No. 6,623,773, which is incorporated in its entirety herein.

It will be appreciated that, while the seasoning bag makes the marinating process easier, cleaner, and more convenient for a consumer, the seasoning bag also permits a consumer to customize the flavor of the food item. Given that the seasoning is applied to the food item in the seasoning bag, a user can easily add additional spices, flavorings, liquids, etc. to the seasoning bag.

The seasoning bag may be any suitable size and/or shape to accommodate one or more food items for marinating. Additionally, the seasoning bag may be constructed of any suitable material and have any suitable thickness. Examples of materials that may be used for the bag include, without limitation, thermoplastic materials or a blend of thermoplastic materials. The films may be made by a conventional cast or blown film process. Useful thermoplastics include, without limitation, polyolefins such as high density polyethylene (HDPE), low density polyethylene (LDPE), linear low density polyethylene (LLDPE), and polypropylene (PP); thermoplastic elastomers such as styrenic block copolymers, polyolefin blends, elastomeric alloys, thermoplastic polyurethanes, thermoplastic copolyesters and thermoplastic polyamides; polymers and copolymers of polyvinyl chloride (PVC), polyvinylidene chloride (PVDC), saran polymers, ethylene vinyl acetate (EVA) copolymers, cellulose acetates, polyethylene terephthalate (PET), ionomer (Surlyn®), polystyrene, polycarbonates, styrene acrylonitrile, aromatic polyesters, linear polyesters, nylon, thermoplastic polyvinyl alcohols; foils, metalized films, wax paper or grease proof paper, nonwoven webs, fabrics, paper, ethylene copolymers, ethylene methyl acrylate (EMA) copolymer, polyethylene terephthalate glycol (PETG) copolymer, polyethylene-propylene copolymers, any suitable combinations thereof, and any other suitable materials.

It is contemplated that storage bags within the teachings of the present invention can include any number of layers and that any number of layers can be used in any of the films used to make the bags by using processes known in the art including, without limitation, co-extrusion and lamination. For example, nylon or ethylene vinyl alcohol copolymer layers can be used to improve the flavor, aroma, and oxygen barrier properties of the bags. Further, one of skill in the art will realize that individual layers, or the components comprising an individual layer, utilized for the bag of the present invention can be selected to provide a specific functional or aesthetic requirement. In a non-limiting example, a UV-resistant layer can be provided within the structure of a layer comprising the bag of the present invention to prevent the photo-degradation of a product positioned within the bag.

Although, for purposes of explanation, the bag has generally been referred to as a seasoning bag containing a seasoning, it will be appreciated that the bag may be used for marinating a food item over a period of time, and/or may contain ingredients suitable for curing a food item. Furthermore, additives may be included such as preservatives, food freshness treatments, anti-microbials, colorants, fragrances, flavors, etc. Examples of suitable seasonings include, but are not limited to, vinegar, sugar, beef base, salt, pepper, glucose solids, hydrolyzed plant protein, hydrogenated peanut oil, yeast extract, citric acid, cream of tarter, herbs, spices, dried fruit, and natural and artificial flavorings. Additional examples of seasonings are disclosed in U.S. Pat. No. 6,623,773, which is incorporated in its entirety herein. Thus, it will be appreciated that the seasoning may be any suitable seasoning for flavoring, marinating, curing and/or otherwise treating a food item.

It will be appreciated that aspects of the above described embodiments may be combined for utilization in a single seasoning bag. Furthermore, it will be appreciated that like shown and/or described features may represent the same or similar features in other embodiments.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor(s) for carrying out the invention. Variations of those preferred embodiments may become apparent to those of ordinary skill in the art upon reading the foregoing description. The inventor(s) expect skilled artisans to employ such variations as appropriate, and the inventor(s) intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A bag for applying a seasoning to a food item, the bag comprising:
a mouth for receiving the food item;
an interior surface; and
a seasoning adhered to at least a portion of the interior surface such that the food item may be seasoned if placed through the mouth into the bag.

2. The bag of claim 1 wherein the interior surface comprises a plurality of valleys and the seasoning is disposed within the valleys.

3. The bag of claim 1 further comprising a microwave susceptor material.

4. The bag of claim 3 further comprising a substrate layer at least partially adhered to the susceptor material.

5. The bag of claim 4 wherein the substrate layer comprises a paper.

6. The bag of claim 1 further comprising a valve for permitting the removal of air from the bag.

7. The bag of claim 1 further comprising a closure.

8. The bag of claim 7 wherein the closure is resealable.

9. The bag of claim 1 wherein the seasoning is a marinade.

10. The bag of claim 1 wherein the seasoning is a curing mixture.

11. The bag of claim 1 wherein the seasoning is adhered with a temperature release adhesive.

12. The bag of claim 1 wherein the seasoning may be released with moisture.

13. The bag of claim 1 wherein the seasoning interacts with the food item to season the food item prior to cooking.

14. The bag of claim 1 wherein the interior surface forms a food item compartment and wherein the bag further comprises a seasoning compartment for storing a second seasoning and a seal disposed to enclose the seasoning compartment, the seal being releasable to permit the second seasoning to enter the food item compartment.

15. A bag for applying a seasoning to a food item, the bag comprising:
a first compartment for storing the food item, the first compartment having a reclosable mouth for receiving the food item;
a second compartment for storing the seasoning; and
a seal disposed to enclose the second compartment, the seal being releasable to permit the seasoning to enter the first compartment and season the food item.

16. The bag of claim 15 wherein the seal is temperature releasable.

17. The bag of claim 15 wherein the seal is moisture releasable.

18. The bag of claim 15 wherein the seal is pressure releasable.

19. A seasoning application kit for enabling a consumer to season a food item, the kit comprising:
a seasoning bag, the bag comprising an interior surface having a seasoning adhered at least partially thereon and an open mouth for inserting a food item into the bag; and
a container for storing the bag prior to use, the container having an opening for removing the bag from the container.

20. The seasoning application kit if claim 19 wherein the seasoning interacts with the food item prior to cooking the food item.

21. The seasoning application kit if claim 19 wherein the container comprises a reclosable lid.
